(19) United States
(12) Patent Application Publication
(10) Pub. No.: US 2005/0064168 A1
(43) Pub. Date: Mar. 24, 2005

(54) Electric field spraying of surgically implantable components

(76) Inventors: James E. Dvorsky, Hilliard, OH (US); K. Bryan Scott, Westerville, OH (US)

Correspondence Address: BATTELLE MEMORIAL INSTITUTE, 505 KING AVENUE, COLUMBUS, OH, 43201-2693, US

(21) Appl. No.: 10/946,980

(22) Filed: Sep. 22, 2004

Related U.S. Application Data
(60) Provisional application No. 60/504,816, filed on Sep. 22, 2003.

(51) Int. Cl. B05D 3/04

(52) U.S. Cl. 428/292.1; 427/2.1; 427/458

(57) ABSTRACT

This invention relates to a method for depositing a coating onto an implantable medical component using electrohydrodynamics (“EHD”). The method utilizes EHD to comminute a suitable liquid which then form fibers or particles. The thus-formed fibers or particles are electrically attracted to the medical component and coat at least one surface of the medical component. A wide-variety of liquid formulations can be utilized to deliver a wide-variety of, for example, therapeutic substances, either alone of in combination. Fiber-based and particle-based coatings may be applied as well as combinations thereof. Also disclosed are medical components comprising such coatings, particularly stents.

This application claims priority to U.S. pat. app. Ser. No. 60/504,816 filed Sep. 22, 2003, the contents of which is hereby incorporated as if fully rewritten herein.

### FIELD OF THE INVENTION

The present invention provides a method of applying a coating to an implantable medical component either alone or in a combination with a therapeutic substance. More specifically, the present invention relates to electric field spray-coating of stents with therapeutic substances, wherein the stents are designed for storing and releasing the therapeutic substances, for instance, such as those used in the treatment of restenosis.

### BACKGROUND OF THE INVENTION

When blood vessels are treated, stents are frequently used to prevent vessel blockage from restenosis. Stents are well-known in the medical arts. A stent is typically an open tubular structure that has a pattern (or patterns) of apertures extending from the outer surface of the stent to the lumen. The stent can have either solid walls or lattice-like walls, and can be either expandable or self-expanding. A stent can be delivered on a catheter and expanded in place or allowed to expand in place against the vessel walls. With the stent in place, restenosis may or may not be inhibited, but the probability and/or degree of blockage is reduced due to the structural strength of the stent opposing the inward force of any restenosis. Restenosis may occur over the length of the stent and be at least partially opposed by the stent. Restenosis may also occur past the ends of the stent, where the inward forces of the stenosis are unopposed.

To reduce or prevent the occurrence of restenosis, there are stent designs which incorporate a therapeutic drug (such as an anti-coagulant, immunosuppressant, or anti-inflammatory) into or onto the stent body, which drug may diffuse or be released after the placement of the stent into a vessel. In one design, the therapeutic drug is coated onto the surface of the stent body. As fluid flows across the surface of the stent, the coating degrades and releases the therapeutic drug from the stent.

The therapeutic drug incorporated into the stent may not be included to prevent restenosis, but rather to treat a medical condition at the site of the stent (for example, an antineoplastic agent to treat a site where a tumor has been removed). As the stent is designed to deliver a therapeutic drug to a local site, for example, a constriction site caused by restenosis, a therapeutic drug may be disposed on the outer stent wall, or the inner stent wall or within the stent wall. To maintain the drug within the space, the drug may be imbedded within a carrier, such as a bioabsorbable gel. The stent further may include a pattern of perforation extending from the outer wall, across the thickness of the wall, and through to the inner wall. The presence of the perforation permits the stent to expand radially in diameter.

It is commonplace to make stents of biocompatible metallic materials, with the patterns cut on the surface with a laser machine. The stent can be electro-polished to minimize surface irregularities since these irregularities can trigger an adverse biological response. However, stents may still stimulate foreign body reactions that result in thrombosis or restenosis. To avoid these complications, a variety of stent coatings and compositions have been proposed both to reduce the incidence of these complications or other complications and restore tissue function by itself or by delivering therapeutic compound to the lumen.

Stents may be coated by simple dip coating with a polymer or a polymer and pharmaceutical/therapeutic agents. Dip coating is usually the most successful for low viscosity coatings. The presence of pharmaceutical agents in polymers usually makes the coating solutions more viscous because the polymers need to encapsulate the drug. Dip coating using high viscosity solutions typically causes bridging, i.e., forming of a film across the open space between structural members of the device. This bridging can interfere with the mechanical performance of the stent, such as expansion during deployment in a vessel lumen.

Implantable components such as stents can also be coated using conventional pneumatic spray methods. However, the quality and quantity of the material deposited on the implantable component are critical and pneumatic spraying methods require especially close control of process parameters such as fluid viscosity, spray nozzle condition, material deposition rates, and target placement relative to the spray nozzle to name a few. Pneumatic spray coating methods can be somewhat inefficient. For example, material lost due to overspray (a function of target component geometry and nozzle placement) and requirements for continuous nozzle maintenance and high solvent concentrations (to prevent clogging and process downtime) are key issues of concern.

During a spray coating process, micro-sized spray particles are deposited on the stent. Particles are lost due to the atomization process and this loss also results in the loss of significant amounts of the pharmaceutical agent(s), which can be quite costly. In order to quickly and efficiently load the stent with an optimum drug dosage, it is desirable to minimize the lost particles so that the amount of drug applied to the stent can be readily predicted from the quantity of material delivered in the coating process.

Several bonding techniques, such as anionic bonding and cationic bonding, can also be used for attaching the polymers and the encapsulated polymers on the surface of the stent. During the ionic bonding process, the polymer is applied to the surface where the bonding between the pharmaceutical agent and the polymer is a chemical mixture rather than a strong bond. In covalent bonding, the attachment of the polymer and the pharmaceutical mixture to the surface of the stent is through a chemical reaction. For example, the stent is first cleaned with a primer that leaves a hydroxyl-terminated group on the surface of the stent. This hydroxyl-terminated group attaches itself to the polymer chain, which in turn contains the pharmaceutical compound chemically attached to it.

It is known to utilize electrostatic spray deposition (ESD) to apply biocompatible coatings onto an implant for implantation in bone. For example, EP Pat. Pub. 1 275 442 to Jansen et al., published Jan. 15, 2003, teaches forcing a precursor solution comprising inorganics such as calcium and phosphate through a capillary which is subjected to an electrical field. The coating, then, enhances the attachment of bone cells to the implant.

It is also known to utilize the application of an electrical charge directly to the material being sprayed to coat medical devices such as stents. U.S. Pat. Pub. No. 2003/0054090 to Hansen, published Mar. 20, 2003 (“Hansen”), for example, teaches the use of a nozzle made of an insulative material to enable the material to be sprayed to be charged directly. As a result of the repulsive force of the electrostatic charge, the material is forced out of the nozzle. Hansen also teaches strictly applying a coating from the outside of the device or stent. Thus, it can be difficult to achieve an adequate and uniform coating over the entire surface of the device since the outer surface effectively shields the inner surface from the effects of the electrostatic charge.

Thus, there exists a need for an apparatus and method for coating medical devices, particularly stents, which does not cause the bridging associated with dip coatings, provides a more efficient spraying which does not result in the overspray and waste of material associated with pneumatic spraying, and which can effectively provide even, uniform coverage over the entire surface of the device.

### BRIEF DESCRIPTION OF THE INVENTION

It is thus an object of the present invention to provide a method for coating an implantable medical component using EHD techniques to form a coating on a surface of the component comprised substantially of fibers. It is a further object of the invention to provide a coating wherein the coating comprises at least one therapeutic substance. It is yet a further object of the invention utilize a solvent which substantially evaporates prior to the coating being formed. It is yet a further object of the invention to provide a melted polymer to an EHD device which techniques then form a coating on a surface of an implantable medical component.

It is another object of the invention to provide a method for coating an interior surface of an implantable-medical component using a EHD-based nozzle-positioned within the interior of the medical component. It is yet a further object of the invention to move the nozzle relative to the medical component along a path through at least a portion of the medical component.

It is yet another object of the invention to provide a method for coating an implantable medical component using a non-conducting mandrel having a first potential and using EHD techniques to form a coating on a surface of the component. It is yet a further object of the invention to effect the first potential with a reference electrode.

It is yet another object of the invention to provide a method for coating an implantable medical component using EHD technology to coat an exterior surface of the medical component with a first material and using EHD technology to coat an interior surface of the medical component. It is yet a further object of the invention to provide a method for coating an implantable medical component with a combination of fibers and particles.

It is yet another object of the invention to provide implantable medical components coated with the aforementioned EHD techniques. It is yet a further object of the invention to provide stents coated with the aforementioned EHD techniques.

### BRIEF DESCRIPTION OF THE DRAWINGS

FIG. 1 illustrates a typical EHD spray configuration.

FIG. 2 illustrates an alternative EHD spray configuration.

FIG. 3 illustrates another alternative EHD spray configuration.

FIG. 4 illustrates the use of EHD to coat an inside surface of a component such as a stent.

FIG. 5 illustrates the use of EHD to spray fibers onto a component such as a stent.

### DETAILED DESCRIPTION OF THE INVENTION

Significant improvements to the process of stent (medical component) coating can be realized by delivering the coating material via electric field spraying, specifically electrohydrodynamic (“EHD”) droplet generation, whereby the formulation is delivered to a spray site where it is exposed to an electric field and forms a so-called cone-jet configuration to produce highly-charged, micron-sized droplets having nearly uniform size. The term “EHD spray” as used herein refers to a freely divided spray of liquid droplets generated by applying an electric field to a liquid at a spray head or spray edge. In EHD spray technology, the potential of the electric field is sufficiently high to overcome the surface tension of the liquid. The cone shape of the liquid at a spray site results from the electric field and surface tension forces balancing each other. The so-called Taylor cone was mathematically described by Geoffrey Taylor; hence, the phenomenon bears his name. At the apex of the cone, a fine jet of the liquid forms that subsequently breaks up into micron (and possibly even sub-micron) sized droplets, fibers, or fibrils having approximately the same size and electrical charge. A unique feature of EHD spraying is the ability to produce a population of aerosol droplets having a controllable and narrow size distribution. Since the charged droplets are uniformly sized, as well as dispersed by their mutual repulsion, the ability to uniformly coat a surface is enhanced.

A common feature of all known EHD spray devices is that the electric charge used to generate the spray is either applied directly to or induced in the spray head. See, e.g., U.S. Pat. No. 6,105,571 to Coffee, issued Aug. 22, 2000, which is incorporated herein by reference. This is in contrast to electrostatic spraying, which refers to a process where the droplets are first formed, generally through atomization, and then the droplets are subsequently charged, generally using a high voltage source, as they exit a spray head.

As used herein, the term “coating” is used in its broadest sense intending to encompass embodiments where an entire stent is coated, only a portion of the stent is coated, a surface (e.g., inner or outer) of the stent is coated, a uniform coating is applied, a non-uniform coating is applied, a layered coating is applied, a surface consists of both coated and non-coated areas, to name a few of the variations.

It may not be necessary to orient the surface of the target such that it is facing the spray nozzle. Depending on the size of the target and distance to the nozzle and other considerations, the use of a translation or rotary stage may not be necessary. This EHD process may also offer an opportunity for coating selected surfaces of the target (e.g., inside versus outside walls or end faces). Thus, EHD may be used to achieve either broad surface coverage of the stent or very specific coverage of the stent surface. For example, as a result of the electric field dispersion and the charged particles produced, EHD spray can provide a “wrap-around” effect which allows for the easy coasting of all stent surfaces (including difficult-to-reach locations). On the other hand, EHD can be used to coat specific stent surfaces or specific portions of a stent surface. (For example, the interior surface can be coated with a drug which treats the blood flowing through the stent, while the outside surface can be coated with an anti-infective material.)

The coating materials may contain a number of components, including biocompatible polymers, therapeutic substances such as those which limit restenosis or which treat atherosclerotic plaque (e.g., blood thinners or anti-infective agents), anti-bacterial agents, and other active ingredients designed to maintain the stability and longevity of the implanted component after it has been surgically placed. Therapeutic substances include, but are not limited to, immunosuppressants such as sirolimus, chemotherapeutics such as paclitaxel, antineoplastics such as actinomycin D, antisense compounds such as resten-NG, anti-inflammatories such as dexamethasone, metalloproteinase inhibitors such as batimastat, and anti-proliferative compounds, and combinations thereof. These substances may also be incorporated into polymers for timed-release applications of the present invention. Additional information on stents, and particularly drug eluting stents can be found at www.tctmd.com.

The therapeutic agent may be applied to the stent from a solution or a suspension. Multiple sprays may be used to apply the material or multiple layers of material may be applied. It is even possible to have different materials on the inside and the outside of the stent (for example, a drug can be released into the bloodstream from the inside surface of the stent, while a restenosis preventive is released from the outside surface of the stent.

When coating an implant, a bioresorbable, biodegradable and/or bio-compatible polymer is generally used. Such polymer can be a single polymer, a co-polymer, or a mixture of polymers selected from the group consisting of, for example, polypeptides, polydepsipeptides, nylon coployamides, aliphatic polyesters, polydihydropyrans, polyphosphazenes, poly(ortho ester), poly(cyano acrylates), poly-anhydrides, modified polysaccharides and modified proteins, and mixtures thereof. Some of these polymers, such as polylactates, can be melted and mixed with the active material. When delivered in this way, the spray conditions may be such that the mixture solidifies either before or after being delivered to the surface of the stent.

Aliphatic polyesters are, for example, selected from the group consisting of poly(glycolic acid), poly(lactic acid), poly(alkylene succinates), poly(hydroxyl-butyrate), poly(butylene diglycolate), poly(epsilon-caprolactone), copolymers, and mixtures, thereof.

Modified polysaccharides are, for example, selected from the group consisting of cellulose, starch-alginate and the glycosaminoglycans, chondroitin sulfate, heparin, heparin sulfate, dextran, dextran sulfate, chitin, chitosan and chitosan sulfate, and mixtures thereof.

The solvent or carrier system used will generally be aqueous-based or include organic solvents, such as ethanol or methylene chloride, depending on the polymer chemical structure. When the active material (with or without a polymer) is delivered from a solution or a suspension, the spray conditions may be controlled such that the solvent evaporates either before or after being delivered to the surface of the stent.

When charged droplets or particles contact a target surface, the electrical charge enhances their adhesion. Since the droplets are not immediately discharged, additional droplets directed toward the target are repelled to areas that have fewer droplets and hence less charge. This effect can yield a high degree of uniformity of the coating on the target surface.

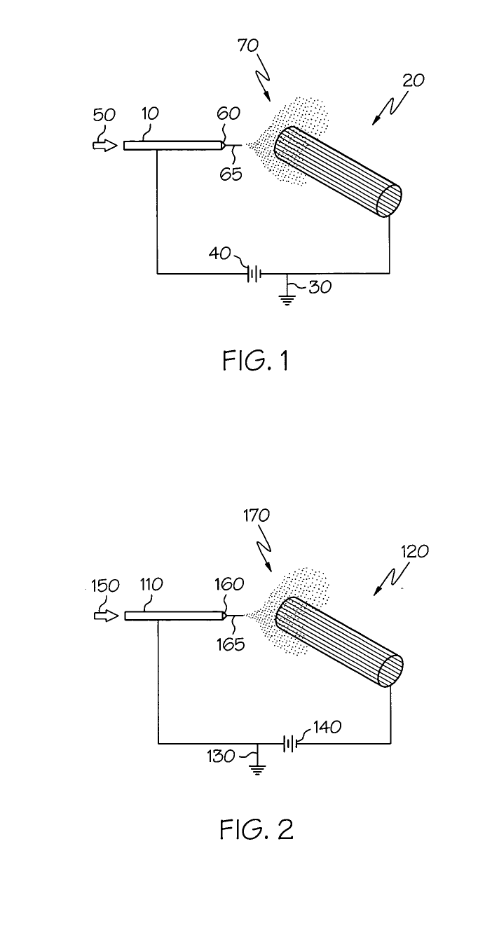

FIG. 1 illustrates a typical EHD spray configuration. As shown, a composition to be sprayed 50 is introduced to spray tube 10. A high voltage source 40 is connected to the spray tube 10. A target component 20 is connected to an earth ground 30. In operation, the composition 50 forms a Taylor cone 60 at the exit of the spray tube 10 which becomes a jet 65 and the jet produces a spray 70 which carries a electric charge.

FIG. 2 illustrates an alternative configuration. For some small target components 120, there are advantages to charging a target 120 and grounding a spray tube 110.

When the spray tube 110 is grounded (FIG. 2), the difference in electrical potential between the spray tube 110 and the fluid reservoir (not shown) is eliminated and the pump and associated plumbing (not shown), are typically at earth potential. With all components associated with a composition 150 at the same potential, there is no need to provide insulation or other means of electrical isolation, as there would be in the configuration shown in FIG. 1. Although not shown, a series resistance may be placed in the conductor attached to the target 120 to control the rate of the charge dissipation of the target 120. This element, combined with the rate of liquid delivery, can control the amount and deposition uniformity of material coating the target 120.

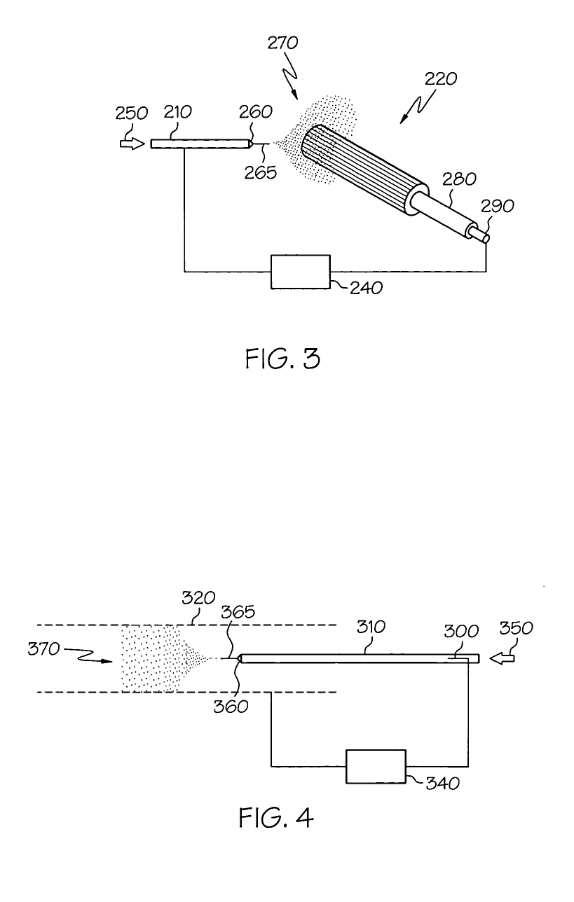

While FIGS. 1 and 2 illustrate that a direct electrical contact to the target 20, 120 is made in order to establish a complete electric circuit, this configuration is not necessary. FIG. 3 illustrates a target 220 can be held on a mandrel 280 or other suitable holding fixture. The mandrel 280 can be conducting or non-conducting. If the mandrel 280 is conducting, the system configuration is similar to that of FIGS. 1 or 2. If it is non-conducting, however, a separate reference electrode 290 is required. In FIG. 3, the reference electrode 290 is on the axis of and through the mandrel 280. If the reference electrode 290 extends through the entire length of the target 220, a capacitive relationship exists that places the target 220 at a potential that is close to (but not exactly at) the potential of the reference electrode 290. Therefore, a strong electric field gradient will exist between the target 220 and the spray tube 210, allowing EHD spraying to occur.

In addition to eliminating the need to directly electrically connect to the target, this geometry has the additional feature of greater uniformity of coating of the sprayed composition 250 to the surface of the target 220. As the charged material 270 strikes and adheres to the target 220, it is not readily discharged by the reference potential. In fact, if the mandrel 280 is comprised of low leakage dielectric material, the target 220 will begin to charge at a potential that approaches that of the spray tube 210. When this occurs, less of the charged material 270 will be attracted to the target 220, especially in areas of highest droplet/charge density; hence, this built-in feedback mechanism can control the uniformity and the amount of sprayed composition 250 applied to the target 220. This process is also valid if the surface of the target is non-conducting.

If the target 220 is metallic or otherwise electrically conducting, greater control over the delivery process can be gained by fabricating the mandrel 280 from resistive or-semi-conducting-material. Deposited-charged material 270 will eventually be discharged through the mandrel 280, but the rate of discharge can be controlled by the conductivity of the mandrel/holding fixture. When this discharge rate is coupled to the fluid flow rate, the amount of deposited sprayed composition 250 can be very precisely controlled while maintaining uniform deposition.

A further feature of the invention is the use of non-conducting holding fixtures/mandrels 280 and other non-conducting shields (not shown) to direct the charged material 270 toward the conducting target 220. Laboratory experiments have demonstrated that the non-conducting surfaces will initially receive a minimal amount of charged material, but since the material 270 cannot be readily discharged, additional droplets are diverted from the dielectric shields and/or the dielectric mandrel/holding fixture 280 and toward the target 220. This maximizes the amount of material 250 that is deposited onto the target 220.

As shown in FIG. 4, it is also possible to coat an internal surface of a target 320. This makes it possible to have different coatings on the internal and external surface of the target. Ideally, the spray tube 310 should be made of non-conducting material, including, but not limited to, suitable polymers or ceramics, to minimize the opportunity of arcing or electrically shorting from the spray tube 310 to the target 320. For this configuration, the composition to be sprayed 350 itself is charged to a high voltage substantially upstream from the site where the Taylor cone 360 is formed. Alternatively, the target 320 may be charged to a high potential, while the composition 350 is earth grounded.

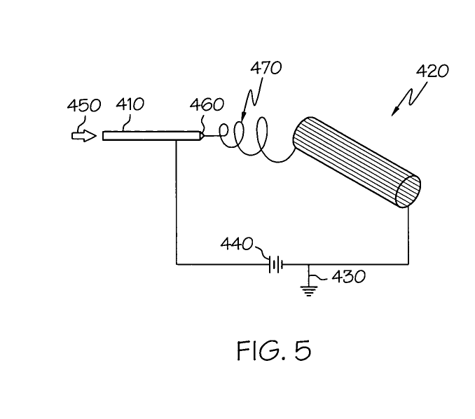

EHD techniques may also be used to electrically spin fibers and these fibers may also be used to form a coating for the medical components of the present invention. As shown in FIG. 5, EHD spinning involves the introduction of material 450 into an electric field, whereby the material 450 is caused to produce fibers 470, which tend to be drawn to an electrode. While being drawn from the material 450, the fibers 420 usually harden, which may involve mere cooling (e.g., where the material 450 is normally solid at room temperature), chemical hardening (e.g., by treatment with a hardening vapor) or evaporation of solvent (e.g., by dehydration). Alternatively, the product fibers 470 may be collected on a suitably located receiver (not shown) and subsequently stripped from it. The fibers 470 obtained by the electrostatic spinning process may be thin, of the order of 0.1 to 25 microns, preferably 0.5 to 10 microns and more preferably 1.0 to 5 microns in diameter. See, e.g., U.S. Pat. No. 4,043,331 to Martin et al., issued Aug. 23, 1977, the contents of which are herein incorporated by reference.

Accordingly, instead of the jet breaking up into droplets, it remains contiguous and forms a fiber 470 (FIG. 5) that, over a period of time, will produce a non-woven matrix of fibers on the surface of the target 420. In the case of stents and similar porous structures, these fibers 470 can provide a secondary mesh that has mechanical resilience and flexibility, as well as the ability to contain and release an active ingredient to its environment. A fiber matrix on the stent may allow the stent to be flexible for placement, yet have a fine enough mesh to prevent tissue infusion into the stent.

1. A method for coating an implantable medical component, comprising:
a. providing a medical component;
b. using EHD techniques to form charged fibers; and
c. forming a coating comprised substantially of the fibers on a surface of the medical component.

2. The method of claim 1, wherein the coating comprises at least one therapeutic substance.

3. The method of claim 2, wherein at least a portion of the medical component includes a foraminous surface, and the step of forming a coating includes forming a web of fibers over at least a portion of the foraminous surface.

4. The method of claim 2, wherein the step of forming a coating includes the step of forming a fibrous mat which defines an upper surface area of a medical device.

5. The method of claim 2, wherein the medical component comprises a stent and the step of forming a coating includes forming a web of fibers over at least a portion of the stent.

6. The method of claim 1, wherein the charged fibers further comprise a solvent that substantially evaporates prior to forming the coating on the surface.

7. The method of claim 2, wherein the charged fibers further comprise a solvent and the solvent substantially evaporates before the therapeutic substance is deposited onto the surface of the medical component.

8. The method of claim 4, wherein the charged fibers further comprise a solvent and the solvent substantially evaporates after the therapeutic substance is deposited onto the surface of the medical component.

9. The method of claim 1, wherein the step of using EHD includes providing melted polymer to an EHD device.

10. The method of claim 7, wherein the coating comprises a polymer material comprising a polylactate.

11. The method of claim 9, wherein the step of forming a coating includes substantially solidifying the fibers and depositing the fibers onto the surface of the medical component.

12. The method of claim 9, wherein the step of forming a coating includes depositing the fibers and substantially solidifying the fibers after depositing the fibers onto the surface of the medical component.

13. A method for coating an interior surface of an implantable medical component comprising the steps of:
a. supplying a liquid to at least one nozzle;
b. positioning the at least one nozzle within the interior of the medical component; and
c. subjecting the nozzle to an electric field, thereby causing the liquid to form at least one electrically-charged Taylor cone which forms at least one electrically-charged jet, and wherein the at least one electrically-charged jet comminutes to form charged material which deposits onto the interior surface.

14. The method of step 13, wherein the material comprises particles.

15. The method of step 13, wherein the material comprises fibers.

16. The method of claim 13, further comprising the step of:
d. moving the nozzle relative to the medical component along a path through at least a portion of the medical component.

17. The method of claim 16, wherein the medical component comprises a stent, and at least a portion of the path of the nozzle is generally axially through a portion of the stent.

18. A method for coating an implantable medical component comprising the steps of:
a. supporting the component on a non-conducting mandrel having a first electrical potential;
b. supplying a liquid to a least one nozzle; and
c. subjecting the nozzle to a second electrical potential, causing the liquid to form at least one electrically-charged Taylor cone which forms at least one electrically-charged jet, comminuting the at least one jet, and forming charged material; and
d. depositing the charged material onto a surface of the medical component.

19. The method of claim 18, wherein the first electrical potential is effected by a reference electrode.

20. A method for coating an implantable medical component comprising the steps of:
a. supplying a liquid comprising a solvent to at least one nozzle;
b. subjecting the nozzle to an electric field, thereby causing the liquid to form at least one electrically-charged Taylor cone which forms at least one electrically-charged jet, wherein the at least one electrically-charged jet comminutes to form charged material which deposits onto a surface of the medical component, and wherein the conditions are such that the solvent substantially evaporates before the therapeutic substance is deposited onto the surface of the medical component.

21. A method for coating an implantable medical component comprising the steps of:
a. providing a non-conducting mandrel having an electrode disposed therein;
b. electrically isolating and supporting the medical component on the non-conducting component;
c. inducing, with the electrode, an electrical potential in the medical component; and
d. using EHD to form a charged material and depositing at least a portion of the charged material onto an exterior surface of the medical component.

22. The method of claim 21, wherein the charged material is at least partially discharged prior to deposition on the exterior surface.

23. A method for coating an implantable medical component comprising the steps of:
a. supporting the component on a non-conducting mandrel having a first electrical potential;
b. supplying a liquid to at least one nozzle;
c. using EHD to form a first charged material and depositing at least a portion of the first charged material onto an exterior surface of the medical component;
d. removing the mandrel from the medical component;
e. supplying a liquid to at least one nozzle positioned at least in part within the interior of the medical component; and
f. using EHD to form a second charged material and depositing at least a portion of the second charged material onto an interior surface of the medical component.

24. The method of claim 23, wherein the step of depositing the first material comprises substantially depositing the first charged material onto the exterior surface and the step of depositing the second material comprises substantially depositing the second charged material onto the interior surface of the component.

25. The method of claim 23, wherein the first material comprises fibers.

26. The method of claim 25, wherein the second material comprises fibers.

27. The method of claim 25, wherein the second material comprises particles.

28. The method of claim 23, wherein the first material comprises particles.

29. The method of claim 28, wherein the second material comprises fibers.

30. The method of claim 27, wherein the second material comprises particles.

31. A method for coating an implantable medical component comprising the steps of:
a. supplying a first liquid to at least one first nozzle;
b. subjecting the first liquid to an electric field, thereby causing the first liquid to form at least one electrically-charged first Taylor cone which forms at least one electrically-charged first jet, and wherein the at least one first jet comminutes to form first charged fibers which substantially deposit onto a first surface of the medical component;
c. supplying a second liquid to at least one second nozzle; and
d. subjecting the second liquid to an electric field, thereby causing the second liquid to form at least one electrically-charged second Taylor cone which forms at least one electrically-charged second jet, and wherein the at least one second jet comminutes to form second charged fibers which substantially deposit onto a second surface of the medical component.

32. An implantable medical component comprising a coating applied by the method of claim 1.

33. A stent comprising a coating applied by the method of claim 2.

34. A implantable medical component comprising a coating applied by the method of claim 13.

35. A stent comprising a interior coating applied by the method of claim 13 and a exterior coating applied by the method of claim 1.

36. A stent comprising a coating applied by the method of claim 27.
